(19) United States
(12) Patent Application Publication
(10) Pub. No.: US 2026/0197223 A1
(43) Pub. Date: Jul. 9, 2026

(54) HIGH ASSURANCE DISTRIBUTED GUARD

(71) Applicant: SPHYRNA SECURITY, Kanata (CA)

(72) Inventors: Paul DUFRESNE, Almonte (CA); Alan MAGAR, Kanata (CA); Brent NORDIN, Ottawa (CA); Peter WHITTAKER, Arnprior (CA); Chris MCKENZIE, Nepean (CA)

(73) Assignee: SPHYRNA SECURITY, Kanata (CA)

(21) Appl. No.: 19/441,216

(22) Filed: Jan. 6, 2026

Related U.S. Application Data
(60) Provisional application No. 63/742,067, filed on Jan. 6, 2025.
(60) Provisional application No. 63/742,069, filed on Jan. 6, 2025.

(51) Int. Cl. H04L 41/042; H04L 12/46; H04L 41/0654

(52) U.S. Cl. CPC H04L 41/042; H04L 12/46; H04L 41/0654

(57) ABSTRACT

The present disclosure describes a high assurance distributed guard that is generally comprised of an administration module, a domain gateway and domain router as well as ingress and egress orchestrators. Each one of these components may be hosted on separate processors to provide some degree of hardware-based separation. The administration module provides a single point of administration for the guard, thereby reducing the complexity of the guard. The egress and ingress orchestrators provide filtering functions for the guard and are configured to connect to external sidecars that can in turn perform more additional, more complex filtering functions. Together these features reduce the complexity of the guard. An immutably sourced transient operating system is also described, whereby a watchdog module maintains independent control over each component's power supply and can force said components to power down in the case of a compromise, and reboot from a fresh (transient) operating system.

### CROSS REFERENCE TO RELATED APPLICATION

The present application claims priority to U.S. Provisional Application No. 63/742,067, entitled “HIGH ASSURANCE DISTRIBUTED GUARD” filed on Jan. 6, 2025, and to U.S. Provisional Application No. 63/742,069, entitled “HIGH ASSURANCE FILTER” filed on Jan. 6, 2025, the contents of which are incorporated herein by reference in their entirety.

### FIELD

The invention relates generally to secure data transfer systems, and more particularly, to a high assurance distributed guard and filter.

### BACKGROUND

Governments and industry have a requirement to transfer data between disparate security domains (networks with different security policies) in a controlled manner. The transfer of data between security domains, especially in cases of a sizeable trust disparity (e.g. different levels of classification), necessitates the use of Cross-Domain Solutions (CDS). While CDS are comprised of a number of components, the key component is typically a high assurance guard. High assurance guards, which are typically built on trusted operating systems, apply security policies to information being transferred between connected security domains. The guard is responsible for controlling all information flow between security domains and ensuring that any data transmitted does not constitute an attempt to leak information (high-to-low) or spread malware (low-to-high). Data that conforms to the security policy is transferred between the security domains, whereas data that contravenes the security policy is prevented from being transferred.

While CDS have been in use for many years, a recent initiative by the National Security Agency (NSA) and the Unified Cross Domain Services Management Office (UCDSMO) has attempted to improve the security of CDS. The Raise The Bar (RTB) strategy is a community effort to rectify identified shortcomings in the design and implementation of currently available CDS.

There are several deficiencies with existing high assurance guards that makes their use problematic. For example, high assurance guards can be highly complex, which is undesirable in the security space. More specifically, high assurance guards have multiple functions including: domain separation and routing (controlling information flow between two or more security domains); data orchestration and filtering (when transferring data between security domains, the data must be appropriately filtered); and, policy enforcement (enforcing transfer policy between security domains). Each of these functions alone is multi-faceted and challenging to implement. Additionally, this functionality must then be supplemented with a multi-role administration capability that supports Two Knowledgeable Person Control (TKPC). Implementing each one of the aforementioned functions, in multiple domains and in one single hardware platform, is complex, which as mentioned above is the antithesis of security. Due to this complexity, high assurance guards often must undergo intense scrutiny as part of an onerous certification process. Subsequent changes to the guard, including small ones (e.g., updating filters), necessitate a re-evaluation of the guard in its entirety.

In addition, current cross domain guards, which are monolithic software constructs running on a single system, are most often centrally managed. A central authority is responsible for defining the security policy that dictates what data can be transferred between security domains and how the data is filtered to ensure that the data is safe to transfer. This works well if there is a central authority that is responsible for the interconnected security domains. However, this approach is less than ideal for communities of interest in which the respective entities are peers or even sovereign nations.

As such, there is a need for an improved high assurance distributed guard that can overcome the deficiencies noted above. Preferably, such a guard would: allow hosting critical guard functionality on separate processing engines; provide each member the means to independently manage data transfer security policies, if they so wish, while ensuring that data transferred is protected even over untrusted networks; and, be comprised of specific components that utilize a transient copy of an operating system to ensure that any compromise of the system is temporary and reset or replaced if the watchdog or administration system detects evidence of compromise.

Additionally, withing the context of CDS, there are numerous cross-domain transfers that occur. More specifically, cross-domain transfers involve the transfer of portable documentation files, such as Microsoft Office™ DOCX and Adobe™ PDF document.

These structured documents are open portable document standards that feature many methods for embedding images, text, style layout, tables, lists, references, citations, collaboration review comments, change tracking, security and protection, and custom extensions. In some formats, scripting, macros, and embedding of programmatic components are supported. These end-user capabilities facilitate rich document authoring features but are recorded in the respective document file format for portability, and this file can be subject to malicious modification by which a user opening the file with an application may be impacted or may include hidden sensitive data, in various forms, for the purpose of exfiltration.

Traditionally document security filtering solutions attempt to detect or remove the offending elements from the document, but there is no guarantee that the document is free from unknown malicious content or embedded sensitive data exfiltration attempts. Detection and removal of content from the document file format can impact valid portions of the document and negatively impact its readability.

Because these types of portable documentation files can contain malicious code or sensitive data hidden within the complex data structure inherent to these file formats, malicious code and data leakage attacks are difficult to identify even with the most advanced filters.

Therefore, there is a need to address these issues, by means of effectively filtering these complex data types so that what is being transferred is guaranteed to be safe to transfer. Preferably, such a filter would: combine optical character recognition (OCR) technology with a system that implements different approaches to reconstructing the new document, while preserving informational accuracy and the primary structure of the document (same number of pages, heading, footer, tables, paragraphs, etc).

### SUMMARY

In an aspect, the present disclosure provides a high assurance distributed guard comprising: a gateway to provide two-way communication with a first network; an egress orchestrator connected to the gateway, the egress orchestrator in one-way communication with the gateway and configured to filter data received from the gateway; and, a domain router connected to the egress orchestrator, the domain router in one-way communication with the egress orchestrator, the domain router to provide two-way communication with a second network, wherein the egress orchestrator is configured to remotely connect to an egress sidecar that handles advanced filtering functions, thereby reducing the complexity of the distributed guard, and wherein the gateway, egress orchestrator and domain router are discreet electrical components, each having a processor, memory and operating system.

In another aspect, the present disclosure provides a high assurance distributed guard system comprising: a plurality of network-attached components connected to a network, each network-attached component in communication with one another and each further comprising a volatile memory unit; a watchdog administration module configured to detect a compromise of the plurality of network-attached components, the watchdog administration module in two-way communication with each one of the plurality of network-attached components, the watchdog administration module further comprised of a non-volatile memory unit, wherein the watchdog administration module independently controls a power source of each one of the network-attached components, and wherein the plurality of network-attached components and the watchdog administration module are configured to operate using an immutably sourced transient operating system.

In yet another aspect, the present disclosures provides a system for securely transferring data between networks, the system comprising: a plurality of high assurance distributed guards, each one of the plurality of high assurance distributed guards further comprising: a gateway; egress and ingress orchestrators in one-way communication with the gateway; and, a domain router connected to the egress and ingress orchestrators; a plurality of domain networks, each one of the plurality of domain networks connected to and in two-way communication with the plurality of high assurance distributed guards through the gateway; and, an elevator network in two-way communication with the plurality of the high assurance distributed guards, the elevator network configured to transfer the data securely between the plurality of high assurance distributed guards, wherein the gateway, the egress and ingress orchestrator and the domain router are discreet electrical components, each having a processor, memory and operating system.

In yet another aspect, the present disclosure provides a method of generating a filtered document from an original document using a high assurance filter, the method comprising the steps of: decomposing the original document into its constituent parts; utilizing an optical character recognition (OCR) system to read and extract visible text in the original document; converting images of the original document into a new image format; and, reconstituting the original document into the filtered document that preserves a structure of the original document, wherein suspicious and hidden content is removed from the original document to the filtered document.

In yet another aspect, the present disclosures provides a system for generating a filtered document from an original document using a high assurance filter, the system comprising: a file intake and triage module to receive the original document and triage the original document based on a document format; a character inference manager module to receive the original document from the file intake and triage module, the character inference manager module to extract information and remove suspicious and hidden content from the original document; and, a document reassembly module configured to receive the extracted information and create the filtered document that preserved a structure of the original document.

### BRIEF DESCRIPTION OF THE DRAWINGS

A detailed description of embodiments of the invention is provided herein below, by way of example only, with reference to the accompanying drawings, in which:

FIG. 1 is an architecture diagram of a high assurance distributed guard, according to an embodiment of the present disclosure;

FIG. 2 is an architecture diagram of a high assurance distributed guard, according to another embodiment of the present disclosure;

FIG. 3 is an architecture diagram of a high assurance distributed guard, according to yet another embodiment of the present disclosure;

FIG. 4 is an architecture diagram of a high assurance distributed guard, according to yet another embodiment of the present disclosure;

FIG. 5 is an architecture diagram of a transient operating system for use with a high assurance distributed guard, according to an embodiment of the present disclosure;

FIG. 6 is an architecture diagram of a system using a plurality of high assurance distributed guards, according to an embodiment of the present disclosure;

FIG. 7 is a block diagram of a method of generating a filtered document using a high assurance filter, according to an embodiment of the present disclosure; and,

FIG. 8 is a block diagram of a system of generating a filtered document using a high assurance filter, according to an embodiment of the present disclosure.

It is to be expressly understood that the description and drawings are only for the purpose of illustration of certain embodiments of the invention and are an aid for understanding. They are not intended to be a definition of the limits of the invention.

### DETAILED DESCRIPTION

The following embodiments are merely illustrative and are not intended to be limiting. It will be appreciated that various modifications and/or alterations to the embodiments described herein may be made without departing from the disclosure and any modifications and/or alterations are within the scope of the contemplated disclosure.

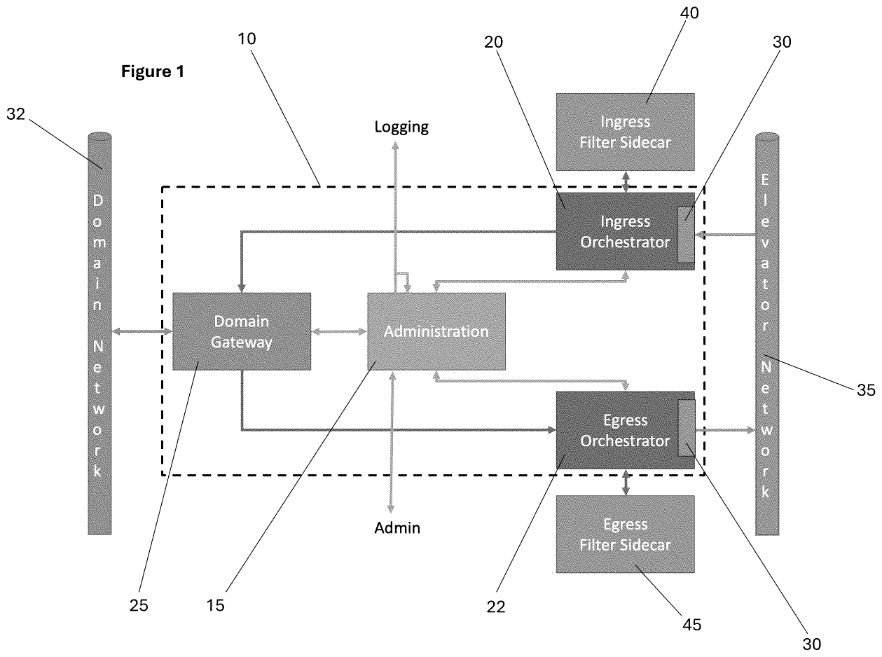

As shown in the below-referenced FIGS. 1 to 6, the present solution provides a distributed guard having reciprocal unidirectional data paths with independent data filtering performed in linear-assured pipelines. A differentiator is that the design results in a separation of responsibilities across multiple internal hosts, each with its own processor, memory and operating system separated by unidirectional network connections. This architecture, as will be further defined, ensures that no single host connects to multiple domains. The linear-assured pipeline framework that is used is flexible enough to support on-board filtering and/or off-board filtering with the use of a filter sidecar. Filtering of ingress and egress streams are handled in isolated filter management systems via orchestrators.

With reference to FIG. 1 and according to an embodiment of the present disclosure, the architecture of a high assurance distributed guard 10 is shown. The guard 10 is comprised of an administration module 15, ingress and egress orchestrators 20, 22, domain gateway 25 and domain router 30. The administration module 15 is connected to and in communication with both the ingress and egress orchestrators 20, 22 and the domain gateway 25 to communicate with a domain network 32. The administration module 15 provides a single point of administration, utilizing user-provided configuration details to generate file system images from which the other hosts boot when these hosts turn on and power up. The ingress and egress orchestrators 20, 22 act as data filters. The ingress and egress orchestrators 20, 22 utilize linear assured pipelines to receive the data, apply filters to the data, verify the data, and then transmit that data to the requisite network once it has been filtered and verified. More specifically, the ingress orchestrator 20 receives the data originating from a network such as an elevator network 35 through a domain router 30. In this embodiment, the ingress orchestrator 20 is connected to an ingress filter sidecar 40, while the egress orchestrator 22 is connected to an egress filter sidecar 45. Both ingress and egress filter sidecars 40, 45 are responsible for handling filtering functions that would otherwise be performed by the ingress and egress orchestrators 20, 22 on their own. Indeed, the ingress and egress filter sidecars 40, 45 are capable of handling complex filtering functions, which meaningfully reduces the complexity of the guard 10. Additionally, due to the everchanging nature of potential threats, filters are routinely updated, upgraded and patched. Therefore, utilizing an ingress and egress filter sidecar 40, 45 reduces potential changes (e.g. updates, patches, upgrades) that may otherwise be required of the guard 10. Such changes may require recertification of the guard, which would be time-consuming and costly. Having an ingress and egress filter sidecar 40, 45 also allows the guard 10 to use commercial or open-source filters, without having to port them to specialized operating systems. In this specific architecture depicted in FIG. 1, the ingress orchestrator 20 is a separate processor from the egress orchestrator 22. A feature of the guard 10 is that its design provides separation of responsibilities across multiple internal hosts, each with its own processor, memory and operating system separated by unidirectional network connections. This ensures that no single host connects to multiple domains. The use of a linear-assured pipeline framework by the ingress and egress orchestrators 20, 22, is flexible and supports both on-board filtering (described in other architectures below) and off-board filtering with the ingress and egress filter sidecars 40, 45. In this embodiment, the domain router 30 is co-located with both the ingress and egress orchestrators 20, 22. A worker skilled in the art would appreciate that “co-located” in this context means being on the same processor. In other words, the functionality of the domain router 30 is split into an “ingress domain router” and an “egress domain router”, each sharing a processor with their respective ingress and egress orchestrators 20, 22.

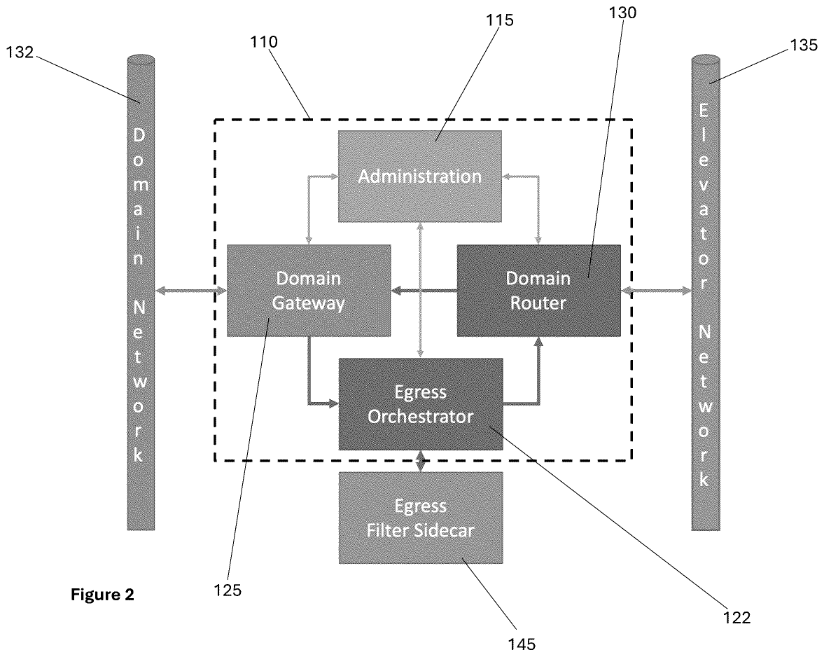

With reference to FIG. 2 and according to an embodiment of the present disclosure, another possible architecture of a high assurance distributed guard 110 is shown, further comprised of an administration module 115, egress orchestrator 122, domain gateway 125 and domain router 130. As shown, the domain gateway 125 is in two-way communication with a domain network 132, whereas the domain router 130 is in two-way communication with an elevator network 135. In this configuration, there is no ingress orchestrator. The egress orchestrator 122 is connected to an egress filter sidecar 145. The egress filter sidecar 145 is responsible for handling filtering functions that would otherwise be performed by the egress orchestrator 122 on their own. The egress filter sidecar 145 is capable of handling complex filtering functions, which meaningfully reduces the complexity of the guard 110. This particular architecture depicts a need for unidirectional transfer. In other words, the architecture only needs one of an ingress or egress of data transfer, and the present FIG. 2 shows a distributed guard 110 with only an egress capability via the egress orchestrator 122. Having only one orchestrator also allows the domain router 130 to be hosted in a separate processor and not co-located on the orchestrator, as was the case in the configuration depicted in FIG. 1.

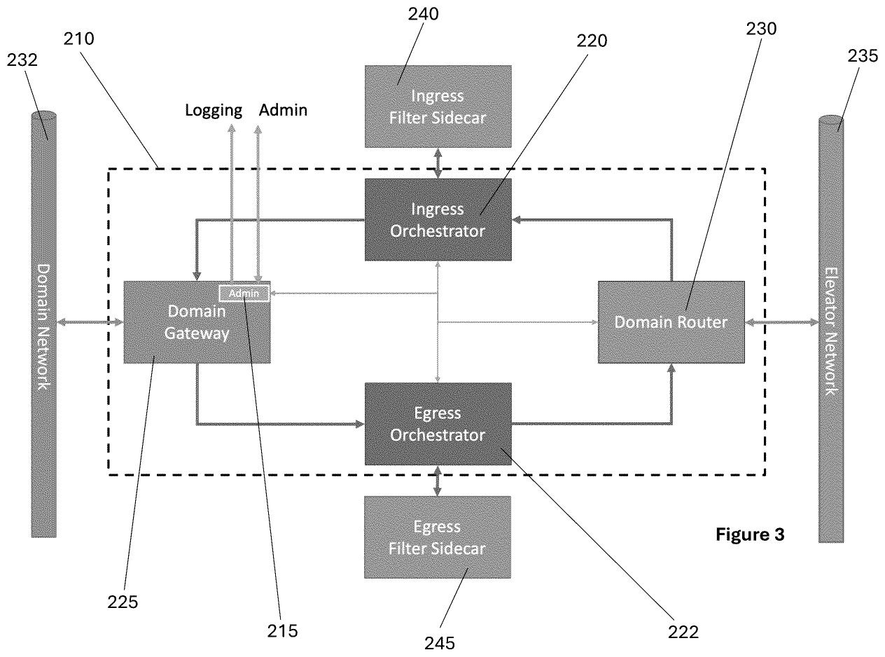

With reference to FIG. 3 and according to an embodiment of the present disclosure, another possible architecture of a high assurance distributed guard 210 is shown, further comprised of an administration module 315, ingress and egress orchestrators 220, 222, domain gateway 225 and domain router 230. In this specific architecture, the administration module 215 is co-located with the domain gateway 225, thereby allowing the domain router 230 to be hosted in a separate processor. The domain gateway 225 is in two-way communication with the domain network 232, whereas the domain router 230 is in two-way communication with the elevator network 235. The ingress orchestrator 220 is connected to an ingress filter sidecar 240, while the egress orchestrator 222 is connected to an egress filter sidecar 245. Both ingress and egress filter sidecars 240, 245 are responsible for handling filtering functions that would otherwise be performed by the ingress and egress orchestrators 220, 222 on their own.

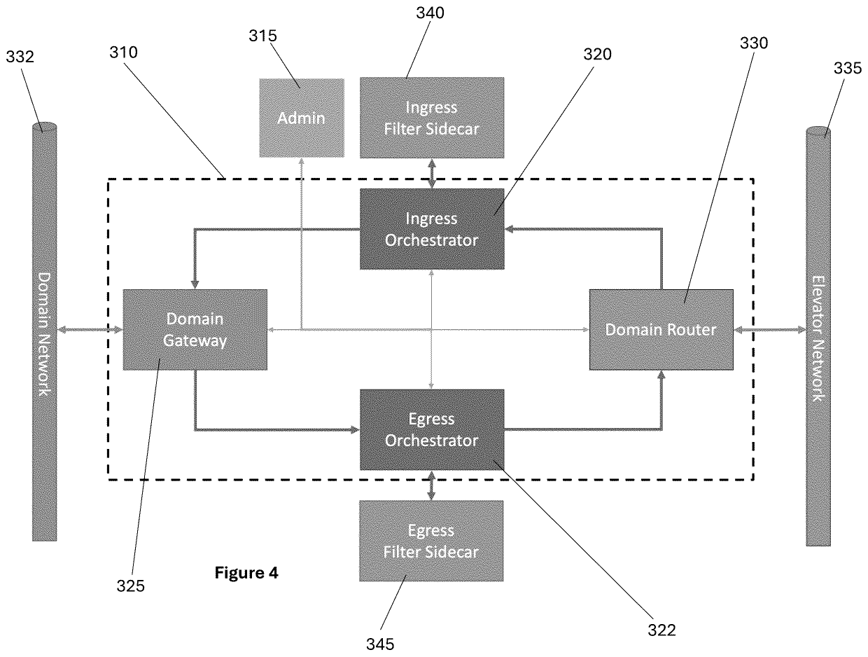

With reference to FIG. 4 and according to an embodiment of the present disclosure, another possible architecture of a high assurance distributed guard 310 is shown, further comprised of ingress and egress orchestrators 320, 322, domain gateway 325 and domain router 330. In this specific architecture, the guard 310 is administered by an administration module 315 externally, so there is no requirement for onboard administration. This architecture allows for the domain router 330 to be hosted in a separate processor. The domain gateway 325 is in two-way communication with the domain network 332, whereas the domain router 330 is in two-way communication with the elevator network 335. The ingress orchestrator 320 is connected to an ingress filter sidecar 340, while the egress orchestrator 322 is connected to an egress filter sidecar 345. Both ingress and egress filter sidecars 340, 345 are responsible for handling filtering functions that would otherwise be performed by the ingress and egress orchestrators 320, 322 on their own.

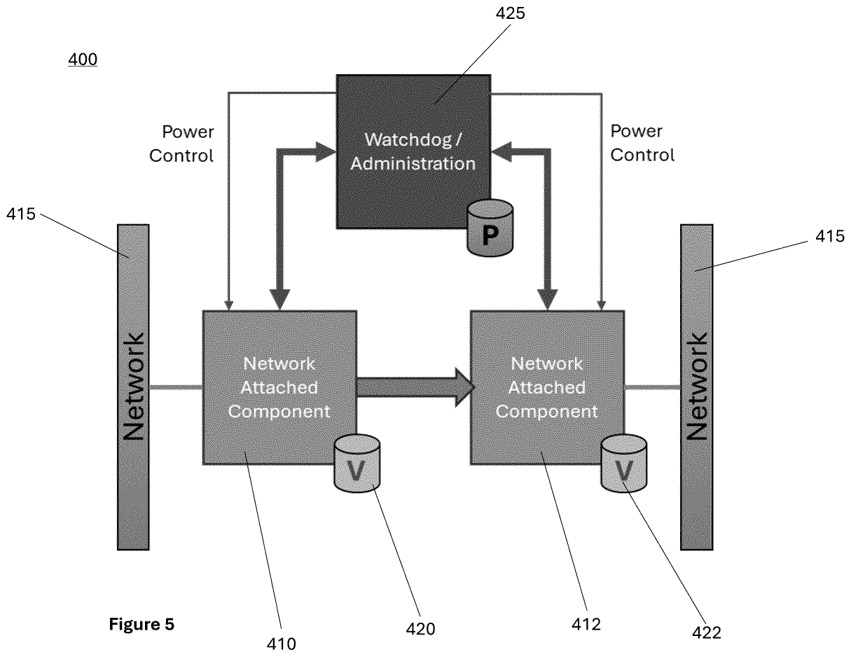

With reference to FIG. 5 and according to an embodiment of the present disclosure, the architecture for an immutably sourced transient operating system 400 is shown for use in a distributed guard (not shown). A worker skilled in the art would appreciate that the immutably sourced transient operating system 400 is contemplated for use with the distributed guards 10, 110, 210, 310 as shown and described in the previous FIGS. 1-4, respectively, to provide high assurance data transfer. However, in another embodiment, the distributed guards 10, 110, 210, 310 may be utilized without this type of operating system 400. As is known in various guard (not shown) architectures, there are a variety of network attached components 410, 412 that are connected to and in communication with a network 415. By way of example not intended to be limiting, network attached components 410, 412 may be a domain router or domain gateway. Similarly, by way of example not intended to be limiting, a data-bearing network 415 may be an elevator network or a domain network. The network attached components 410, 412 are each comprised of random-access memory (RAM) units referred to as volatile memory units 420, 422. These volatile memory units 420, 422 serve to mitigate the risk of compromise. When the guard (not shown) boots, the operating system and application image are provided, out-of-band, from a watchdog or administration system 425 and stored in the volatile memory units 420, 422. Therefore, any changes to the operating environment of the network attached components 410, 412 are temporary and overwritten on the next reboot. The watchdog system 425 maintains independent control over the power supply of each network attached component 410, 412. The watchdog system 425 collects logs from the network attached components 410, 412 as well as any active and other externally connected components. Those logs are analyzed for evidence of compromise or attempts to compromise the network attached component 410, 412 or other component in question, and can force any one of said component to power down or reboot from a fresh, unmodified copy of the operating environment image. If a new vulnerability or attack vector has been exposed, the operating environment can be tested and corrected out of band, and the component rebooted with a fresh image.

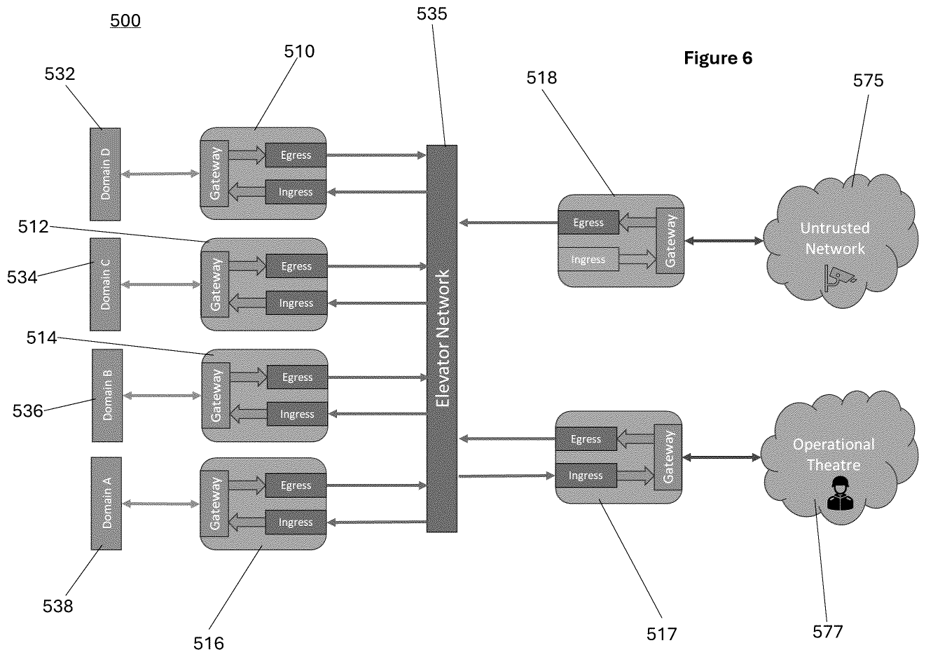

With reference to FIG. 6 and according to an embodiment of the present disclosure, a system 500 utilizing a plurality of distributed guards 510, 512, 514, 516, 517, 518 is shown. A worker skilled in the art would appreciate that any one of the previously described guards (10 in FIGS. 1, 110 in FIGS. 2, 210 in FIGS. 3 and 310 in FIG. 4) could be utilized in the present system 500. Each one of the guards 510, 512, 514, 516 is in two-way communication with an elevator network 535 of the system 500. Each one of the guards 510, 512, 514, 516 is also in two-way communication with separate domain networks 532, 534, 536, 538. Each one of the guards 510, 512, 514, 516 is therefore administered by the administration authority of each attached domain network 532, 534, 536, 538, respectively, while still allowing controlled flow of data between domains 532, 534, 536, 538 via the elevator network 535. Two additional distributed guards 517, 518 are also shown connected to the elevator network 535. These illustrate an embodiment whereby high exposure networks such as an untrusted network 575 or network in a warzone 577 could be integrated into the system 500 with a high level of assurance. This high level of assurance is possible because if either one of the distributed guards 517, 518 is compromised, it does not impact the other domain networks 532, 534, 536, 538 as the guards 517, 518 are not directly connected to any of the domain networks 532, 534, 536, 538 with which they exchange data.

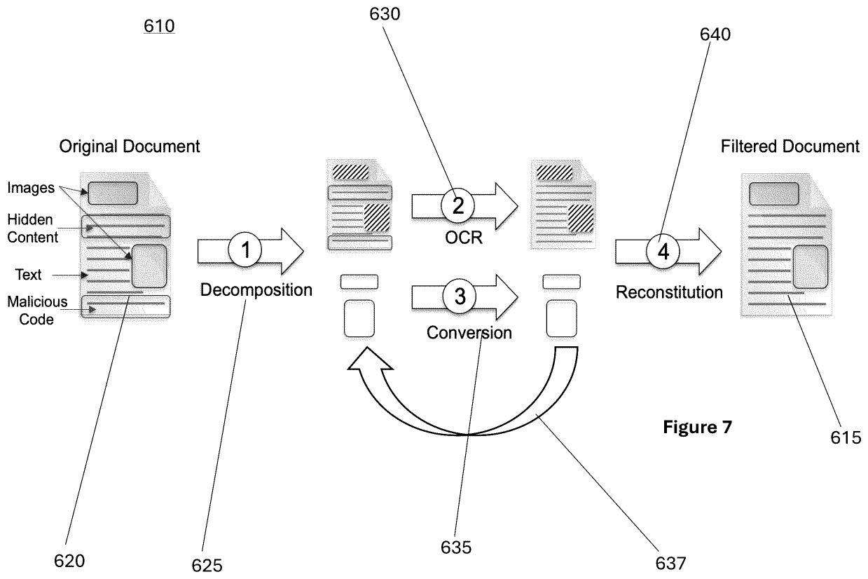

With reference to FIG. 7 and according to an embodiment of the present disclosure, a block diagram of a method of generating a filtered document using a high assurance filter 610 is shown. A worker skilled in the art would appreciate that the present system and method 610 is utilized when the end user requires a searchable/editable filtered document 615 rather than simply an image of the original document 620. In a first step 625, the original document 620 is decomposed into its component parts. Components parts may include images and the document itself. In a second step 630, the original document 620 is read using OCR to maintain only visible text data. OCR is an effective way to filter out both hidden data and malicious code that may be present in the original document 620. In a third step 635, the image files are scanned and converted into a new image format without any accompanying metadata. In an optional step 637, the process may be repeated whereby the image files are scanned and converted into different image formats to further ensure that no hidden information is retained. In a fourth step 640, the OCR text and converted images are reconstituted in the newly created filtered document 615. The filtered document 615 closely approximates the original document 620.

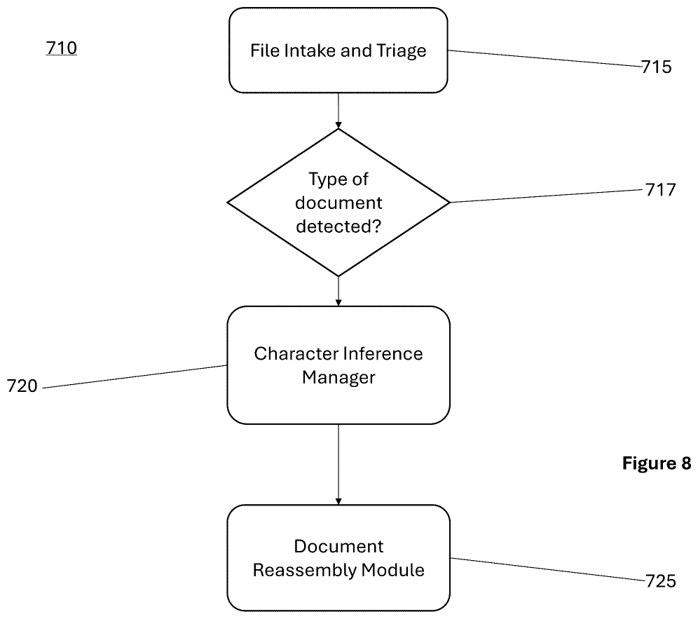

With reference to FIG. 8 and according to an embodiment of the present disclosure, a block diagram of a system for generating a filtered document using a high assurance filter 710 is shown. The system 710 is generally comprised of an optional file intake and triage module 715, a character inference manager module 720 and a document reassembly module 725. The file intake and triage module 715 is configured to receive portable documentation files to be filtered. In an embodiment, the module 715 receives them via a designated watched file directory, although other methods are possible. The module 715 supports triaging of multiple file formats, including but not limited to DOCX, PDF, PPTX and other formats. The system 710 is configured to deconstruct the document to extract information. Depending on the document format type detected 717, a suitable character inference manager 720 will be executed, which is configured to perform numerous functions. The character inference manager 720 is configured to understand the syntax of the original document, and extracts document images and replaces them with placeholder images that contain a unique image identifier. The images will be further converted or scanned to remove metadata or detect image exploits or watermarking. The module 720 then identifies header and footer sections, tables, TOC (Table of Contents), and prefixes heading text with basic markup notation that can be read by the OCR process in isolation. The module 720 then identifies and replaces any overly complex structures, which are difficult to infer post-OCR processing into more basic structures. For example, page margins may be normalized to avoid mis-inference of paragraph placement as another structure type, or hyperlinks are stripped from text to aid in OCR readability and to eliminate propagation of URLs to potentially unsafe external web sites. Similarly, text or paragraphs with font styling too small to be read by the OCR will be removed, and text that is styled invisibly such as white text on a white background will not be propagated as invisible characters cannot be read by the OCR system. The module 720 is then configured to replace document font and styling as necessary to aid in accurate OCR processing, before reassembling the document with these process sanitization changes. The module 720 converts the extracted document sections into a series of suitable files, such as PNG or other image files and executes the OCR system to convert the image document section files into extracted character data. Finally, the module 720 executes the configured pluggable document reassembly module 725, passing the extracted data along with extracted document images to the document reassembly module 725. In an embodiment, the document reassembly module 725 then creates a new, empty document using the same format specification as the original from the combination of the extracted data to recreate document structures that were present in the original document. However, in another embodiment, the document reassembly module 725 creates a document using a different format specification as the original. The document reassembly module 725 is configured to re-create the original document in a variety of formats, provided that the content extraction steps are followed, thereby making the new document content substantively the same as the old document. For example, a table structure in the original document will be recreated in a table in the new document, not a series of space or tab separated words. The extracted text that matches the collected unique image identifiers are replaced with the original image files in the same shape and size. No metadata or source document scripting, macros, external hyperlinks, or other embedded content are ported over. Finally, the file is written to a designated destination, such as for example an output file directory. A worker skilled in the art will appreciate that the system 710 is executed in an isolated execution environment with limited access to it computing host environment. In an embodiment, only file read/write access to designated directories for the purpose of document file intake and reassembly output is permitted. Embedded hyperlinks, macros or scripts that would execute when the document was read, would not result in access to the computing host file system, processes, or network, thereby maintain system security when handling the processing.

With further reference to FIGS. 7 and 8, a method of generating a filtered document from an original document using a high assurance filter is shown. The method comprising the steps of: decomposing the original document into its constituent parts; utilizing an optical character recognition (OCR) system to read and extract visible text in the original document; converting images of the original document into a new image format; and, reconstituting the original document into the filtered document that preserves a structure of the original document. Suspicious and hidden content is thus removed from the original document to the filtered document. A system is also shown, the system for generating a filtered document from an original document using a high assurance filter, the system comprising: a file intake and triage module to receive the original document and triage the original document based on a document format; a character inference manager module to receive the original document from the file intake and triage module, the character inference manager module to extract information and remove suspicious and hidden content from the original document; and, a document reassembly module configured to receive the extracted information and create the filtered document that preserved a structure of the original document.

With further reference to FIGS. 7 and 8, a system and method for generating a filtered document from an original document using a high assurance filter is disclosed. The method decomposes the original document then utilizes an OCR system to extract visible text only. The method then scans and converts the images into a new image format, to then reconstitute the original document into a new, filtered document. In the data extraction step, the method removes suspicious and hidden content, such as metadata, macros, scripting, external hyperlinks, watermarking, and other invisible content to make the filtered document safe. The system is comprised of a file intake and triage module to sort the original document, a character inference manager module to extract information and remove suspicious and hidden content from the original document and a document reassembly module to reconstruct the original document and preserve its basic structure.

Although various embodiments of the present invention have been described and illustrated, it will be apparent to those skilled in the art that numerous modifications and variations can be made without departing from the scope of the invention, which is defined in the appended claims.

1. A high assurance distributed guard comprising:
a gateway to provide two-way communication with a first network;
an egress orchestrator connected to the gateway, the egress orchestrator in one-way communication with the gateway and configured to filter data received from the gateway; and,
a domain router connected to the egress orchestrator, the domain router in one-way communication with the egress orchestrator, the domain router to provide two-way communication with a second network,
wherein the egress orchestrator is configured to remotely connect to an egress sidecar that handles advanced filtering functions, thereby reducing the complexity of the distributed guard,
and wherein the gateway, egress orchestrator and domain router are discreet electrical components, each having a processor, memory and operating system.

2. The high assurance distributed guard of claim 1 further comprised of an administration module, the administration module in two-way communication with the gateway, the egress orchestrator and the domain router, to provide a singular point of administration.

3. The high assurance distributed guard of claim 1 further comprised of an ingress orchestrator connected to the gateway, the ingress orchestrator in one-way communication with the gateway and configured to filter data sent to the gateway.

4. The high assurance distributed guard of claim 2 further comprised of an ingress orchestrator connected to the gateway and the administration module, the ingress orchestrator in one-way communication with the gateway and two-way communication with the administration module, the ingress orchestrator configured to filter data sent to the gateway.

5. The high assurance distributed guard of claim 3 further comprising an ingress sidecar in two-way remote communication with the ingress orchestrator, the ingress sidecar configured to handle advanced filtering functions.

6. The high assurance distributed guard of claim 4 further comprising an ingress sidecar in two-way remote communication with the ingress orchestrator, the ingress sidecar configured to handle advanced filtering functions.

7. The high assurance distributed guard of claim 1 further comprising an administration module, the administration module co-located with the domain gateway to allow the domain router to be hosted in a separate processor.

8. A high assurance distributed guard system comprising:
a plurality of network-attached components connected to a network, each network-attached component in communication with one another and each further comprising a volatile memory unit;
a watchdog administration module configured to detect a compromise of the plurality of network-attached components, the watchdog administration module in two-way communication with each one of the plurality of network-attached components, the watchdog administration module further comprised of a non-volatile memory unit,
wherein the watchdog administration module independently controls a power source of each one of the network-attached components,
and wherein the plurality of network-attached components and the watchdog administration module are configured to operate using an immutably sourced transient operating system.

9. The high assurance distributed guard system of claim 8 wherein upon detecting the compromise, the watchdog administration module is configured to shut down an affected network-attached component and reboot the network-attached component from the immutably sourced transient operating system.

10. The high assurance distributed guard system of claim 9 wherein the high assurance distributed guard comprises:
a gateway to provide two-way communication with a first network;
an egress orchestrator connected to the gateway, the egress orchestrator in one-way communication with the gateway and configured to filter data received from the gateway; and,
a domain router connected to the egress orchestrator, the domain router in one-way communication with the egress orchestrator, the domain router to provide two-way communication with a second network,
wherein the egress orchestrator is configured to remotely connect to an egress sidecar that handles advanced filtering functions, thereby reducing the complexity of the distributed guard,
and wherein the gateway, egress orchestrator and domain router are discreet electrical components, each having a processor, memory and operating system.

11. The high assurance distributed guard system of Claim 10, wherein the high assurance distributed guard is further comprised of an administration module, the administration module in two-way communication with the gateway, the egress orchestrator and the domain router, to provide a singular point of administration.

12. The high assurance distributed guard system of Claim 10, wherein the high assurance distributed guard is further comprised of an ingress orchestrator connected to the gateway, the ingress orchestrator in one-way communication with the gateway and configured to filter data sent to the gateway.

13. The high assurance distributed guard system of Claim 11, wherein the high assurance distributed guard is further comprised of an ingress orchestrator connected to the gateway and the administration module, the ingress orchestrator in one-way communication with the gateway and two-way communication with the administration module, the ingress orchestrator configured to filter data sent to the gateway.

14. The high assurance distributed guard system of Claim 12, wherein the high assurance distributed guard is further comprised of an ingress sidecar in two-way remote communication with the ingress orchestrator, the ingress sidecar configured to handle advanced filtering functions.

15. The high assurance distributed guard system of Claim 13, wherein the high assurance distributed guard is further comprised of an ingress sidecar in two-way remote communication with the ingress orchestrator, the ingress sidecar configured to handle advanced filtering functions.

16. The high assurance distributed guard system of Claim 10, wherein the high assurance distributed guard is further comprised of an administration module, the administration module co-located with the domain gateway to allow the domain router to be hosted in a separate processor.

17. A system for generating a filtered document from an original document using a high assurance filter, the system comprising:
a file intake and triage module to receive the original document and triage the original document based on a document format;
a character inference manager module to receive the original document from the file intake and triage module, the character inference manager module to extract information and remove suspicious and hidden content from the original document; and,
a document reassembly module configured to receive the extracted information and create the filtered document that preserved a structure of the original document.
